(19) United States
(12) Patent Application Publication
(10) Pub. No.: US 2012/0321376 A1
(43) Pub. Date: Dec. 20, 2012

(54) METHODS OF MANUFACTURE

(76) Inventor: Albert Edward David Walters, Rotherham (GB)

(21) Appl. No.: 13/576,931

(22) PCT Filed: Feb. 7, 2011
(86) PCT No.: PCT/GB11/50203

§ 371 Date: Sep. 5, 2012

(30) Foreign Application Priority Data
Feb. 10, 2010 (GB) 1002249.9

(51) Int. Cl. F03D 1/06; B29C 65/54; B29C 43/18; B29C 70/84; B32B 7/08

(52) U.S. Cl. 403/267; 156/91; 264/263

(57) ABSTRACT

A method of forming an aerodynamic arrangement (10) comprises providing a plurality of segments (16), providing elongate connecting means (20). The segments are connected to one another with the elongate connecting means. The method further includes introducing a curable securing composition into the connecting means, and allowing the securing composition to cure.

This invention relates to methods of manufacture and, for example, to methods of manufacturing articles, which may have a length greater than 20 metres. More particularly, but not exclusively, the invention relates to wind turbine blade arrangements, and to methods of forming wind turbine blade arrangements. The invention may also relate to wind turbine blades, to wind turbine blade sections, to methods of forming wind turbine blades, and to methods of forming wind turbine blade sections.

Wind turbine blades are typically made from composite mouldings, which can be over 40 metres in length. Such mouldings, and the methods of manufacturing mouldings, can be disadvantageous, in that a defect in a moulding can lead to the scrapping of the whole moulding which can be very expensive. The process is very time consuming, due to the length of the mouldings. The longitudinal strength of the blade is entirely dependent upon the strength of the moulded material. Transport over public roads of wind turbine blades which are over 40 metres in length is very difficult and expensive, thereby precluding the location of wind turbines in some places due to inaccessibility.

According to one aspect of this invention, there is provided a segment of an article, the segment comprising a main body and a holding member in the main body, the holding member being configured to receive therethrough a region of an elongate connecting arrangement.

The main body may include at least one end region comprising an engaging edge for engaging an adjacent segment. The, or each, engaging edge may comprise a wall. In one embodiment, the holding member may comprise an elongate tubular member.

According to another aspect of this invention, there is provided a method of forming a segment of an article, the method comprising forming a main body of the segment, and arranging in the body a holding member in figure to receive therethrough a region of an elongate connecting arrangement.

The method may comprise forming at least one engaging edge of the main body. The step of forming the, or each, engaging edge comprises forming a wall extending across the main body.

According to another aspect of this invention, there is provided an article comprising a plurality of segments and elongate connecting means extending through the segments to connect the segments to one another. The article may comprise an aerodynamic arrangement, for example a wind turbine blade arrangement. The wind turbine blade arrangement may comprise a wind turbine blade or a wind turbine blade section.

The wind turbine blade section may be a longitudinal section. The wind turbine blade section may be a longitudinal blade half section.

The article may comprise a tip and a root, and the plurality of segments may comprise a tip segment and a root segment, and the elongate connecting means may extend from the tip segment to the root segment.

The elongate connecting means may comprise at least one tendon extending from the tip segment to the root segment. Desirably, the elongate connecting means comprises a plurality of tendons.

The connecting means may comprise a connecting tube extending through the segments, and an elongate connecting arrangement extending through the connecting tube. The method may comprise introducing the securing composition into the connecting tube such that the securing composition extends along substantially the length of the connecting tube.

The connecting means may comprise a respective holding member in each segment. The holding members may be connected to one another to provide the connecting tube.

The elongate connecting arrangement may extend through the holding members. The elongate connecting arrangement may comprise an elongate element, which may comprise a filament.

In one embodiment, the elongate connecting arrangement may comprise a plurality of the elongate elements. The elongate elements may extend side by side through the holding members.

Each holding member may comprise an elongate tubular member and the elongate connecting arrangement may extend axially through the tubular members. The connecting arrangement may be secured to the holding members in the tip and root segments.

Desirably, the connecting arrangement is secured to the holding member in each segment. The connecting arrangement may be secured to the holding members by a securing composition, which may comprise a plastics material, such as a resin.

The resin may comprise one or more of an epoxy resin, a vinyl ester resin, a polyester resin, a phenolic resin, a polyurethane resin, a vegetable based resin, or any other suitable resin. The resin may have low viscosity, and/or high adhesive strength, and/or high tensile strength.

At least one of the elongate elements may comprise introducing means through which the securing composition can be introduced into at least one of the holding members. The securing composition may be injected through the introducing means. The introducing means may comprise an elongate delivery tube.

Each segment may have at least one co-operating formation so that the, or each, co-operating formation on adjacent segments can co-operate with each other to align the segments with each other.

The co-operating formations may comprise a spigot and a socket, the spigot on one segment being configured to be received in the socket of the adjacent segment.

A seal may be provided between the spigot and the socket. The seal may comprise a resilient member, or may be a material injected into a gap between the spigot and the socket, the material being curable to form the seal.

The end regions of the holding members of adjacent segments may be aligned with one another. Desirably, the end regions of the holding members of adjacent blade segments abut each other.

The connecting means may include joining members to join to each other the end regions of the holding members of adjacent segments. Each joining member may comprise a sleeve. In one embodiment each sleeve may be an external sleeve, which may extend around the end regions of the holding members of adjacent segments to join the holding members to each other. In another embodiment, each sleeve may be an internal sleeve, and the end regions of the holding members may extend around the internal sleeve.

A lightning conductor may be provided in the article. A containment member may extend from the root of the article to the tip thereof. The lightning conductor may be provided in the containment tube. The containment tube may comprise a plurality of tube members, wherein a respective tube member may be provided in each segment.

According to another aspect of this invention, there is provided a wind turbine blade comprising a plurality of blade sections described above. The wind turbine blade may comprise two blade sections described above. The blade sections may have edges, and may be attached to one another along their edges. The edges may be longitudinal edges.

According to another aspect of this invention, there is provided a method of forming an article comprising providing a plurality of segments, providing elongate connecting means, and connecting the segments to one another with the elongate connecting means.

The method of forming the article may be suitable for forming an article having a length of at least 20 metres. For example, the article may comprise a wind turbine blade arrangement. The wind turbine blade arrangement so formed may comprise a wind turbine blade or a wind turbine blade section.

The segments may be connected to one another at junctions between adjacent segments. The junctions may be provided at engaging end edges on each segment.

The elongate connecting means may comprise at least one tendon. Desirably, the elongate connecting means comprises a plurality of tendons. The plurality of segments provided may comprise a tip segment and a root segment. The elongate connecting means may extend from the tip segment to the root segment.

The connecting means may comprise a holding member in each segment, and the method may include arranging a respective holding member in each segment. Each holding member may comprise a tubular sheath.

The connecting means may further include an elongate connecting arrangement and the method may include arranging the connecting arrangement to extend through the holding members. The connecting arrangement may comprise a plurality of elongate elements.

At least one of the elongate connecting elements may comprise an introducing means having distal and proximal ends. The distal end may be arrangeable adjacent the tip of the blade. The proximal end may be arrangeable adjacent the root of the blade. The introducing means may comprise an elongate delivery tube

The method may comprise arranging the elongate elements in the holding member at the tip segment. The step of arranging the elongate elements in the tip segment may include arranging the introducing means in the holding member of the tip segment.

The method may include a first securing stage comprising introducing a securing composition through the introducing means into the holding member in the tip segment. The step of introducing the securing composition may comprise injecting the securing composition through the introducing means into the holding member.

The securing composition may pass through the introducing means, to pass out of the distal end of the introducing means into the holding member and thereafter flow through the holding member.

Each segment may have at least one connecting edge to engage the connecting edge of the, or each, adjacent segment when the segments are connected to each other. Each segment may comprise co-operating formations to co-operate with one another to align the segments in a desired position to be connected together.

The method may include arranging the segments in alignment with each other, such that the connecting edge of each segment engages the connecting edge of the adjacent segment.

The step of arranging the connecting edges of adjacent segments in engagement with each other may comprise joining the holding members of adjacent segments to one another. Each joining member may comprise a sleeve extending around the end regions of adjacent holding members.

The method may comprise arranging the elongate connecting arrangement to extend through the holding members of each segment, and introducing a securing composition into at least the root segments. The step of introducing the securing composition may comprise introducing the securing composition into all of the segments.

The step of engaging the segments with one another may comprise pulling the segments together, so that the joining members on each holding member are arranged on the end region of adjacent holding members across the junction between said adjacent holding members.

The introduction of the securing composition into the, or each, remaining segment may be via the proximal end of the introducing means. In one embodiment, the introducing means may extend from the root segment to the segment adjacent the tip segment.

The securing composition introduced into the introducing means may pass therealong to the segment adjacent the tip segment. The composition may flow from the introducing means through the holding members to the root segment.

The introducing means may comprise an introducing point via which the securing composition can be introduced. The introducing means may comprise a plurality of the aforesaid introducing points spaced along the plurality of holding members, via each of which the securing composition can be introduced.

Indicating means, which may comprise tubular portions, can be provided at the, or each, introducing point for the securing composition, whereby the flow of fluid out of the indicating means is an indication that the holding members contain the securing composition.

The indicating means may comprise indicator tubes. The indicator tubes may be provided at the engaging end portions one or more of the segments. One of the indicator tubes may be provided at the proximal end of the root segment.

According to another aspect of this invention, there is provided a method of forming a wind turbine blade comprising forming a plurality of sections as described above and attaching the sections to one another.

The method may comprise forming two blade sections and attaching the blade sections to each other.

The blade sections may have edges, and may be attached to one another along their edges.

According to another aspect of this invention, there is provided a moulding method comprising arranging a plurality of first forming elements in a first moulding member, such that the first forming elements define a plurality of recesses between each other in the first moulding member, arranging a plurality of second forming elements in the first moulding member in the recesses, such that each recess receives a respective one of the second forming elements, presenting the first and second moulding members to each other, arranging a moulding material in the mould, and pressing the first and second moulding members onto each other to compress the forming elements and form an article.

The moulding material may be a curable moulding material, such as a resin, for example an epoxy resin, a vinyl ester resin, a polyester resin, a polyurethane resin, a vegetable based resin, a methacrylate resin, or other suitable resin.

The first and second forming elements may have tapering sides to allow the second forming elements to be received in the recesses. In one embodiment, the first and second forming elements may have a profile which is in the shape of an isosceles trapezium.

The tapering sides of the first and second forming elements may allow cooperation between the first and second forming elements. The tapering faces of the first and second forming elements may constitute front and rear faces, and the faces having the shape of an isosceles trapezium may comprise opposite side faces. It will be appreciated that the faces may have any suitable shape appropriate for the article to be moulded

The first and second forming elements may be arranged in rows, and the rows may be staggered relative to each other, such that the first forming elements in one row are adjacent recesses in the adjacent row.

The method may include arranging reinforcing material in the first moulding member before arranging the first forming elements therein.

Further reinforcing material may be arranged on the plurality of first forming elements after arrangement of the first forming elements in the first moulding member. The further reinforcing material is desirably arranged in the recesses in contact with the first mentioned reinforcing material on the first moulding member.

Further reinforcing material may be arranged on the second moulding member prior to presenting the first and second moulding members to each other.

The moulding material may be arranged on the first moulding member before the first and second moulding members are presented to each other. Alternatively, the first and second moulding members may be presented to each other to provide a mould, and the moulding material may be arranged in the mould. The arrangement of the moulding material in the mould may be by injecting the moulding material into the mould.

The forming elements may be formed of a polystyrene material. For example the forming elements may be formed of closed cell polystyrene. Alternatively, the forming elements may be formed of a thermoplastic olefinic foam, or other suitable closed cell foam.

The method may comprise a method of forming a wind turbine blade arrangement. The wind turbine blade arrangement may comprise a wind turbine blade or a wind turbine blade segment.

According to another aspect of this invention, there is provided an article comprising a plurality of first forming elements defining recesses therebetween, a plurality of second forming elements, wherein a respective one of the second forming elements is arranged in each recess, and a binding material provided between the forming elements to bind the forming elements to each other.

The first forming elements may be arranged in adjacent rows, and the forming elements in each row may be adjacent a recess in each adjacent row.

The article may comprise reinforcing material extending around the forming elements. The reinforcing material may also extend between adjacent forming elements.

A holding tube may extend through the forming elements.

Each forming element may have opposed tapering faces, which may be of a rectangular configuration. Each forming element may also have opposed faces having the shape substantially of an isosceles trapezium.

An embodiment of the invention will now be described by way of example only, with reference to the accompanying drawings, in which:

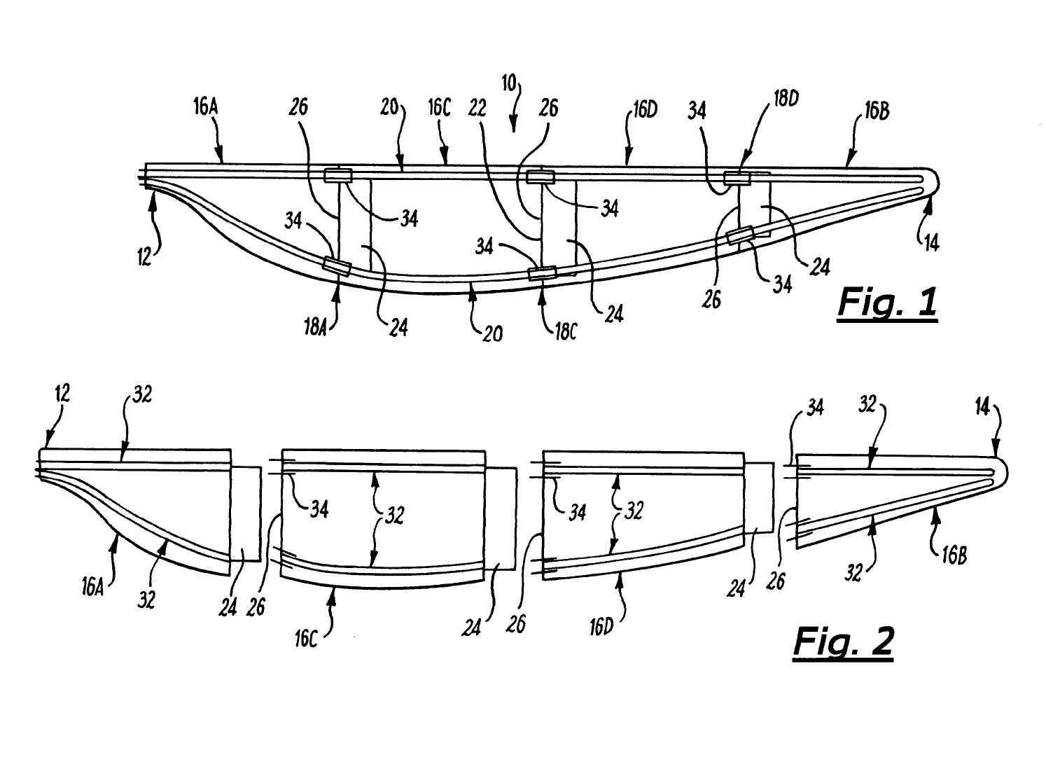

FIG. 1 is a top plan view of an article, which in the embodiment shown is in the form of a longitudinal wind turbine blade section;

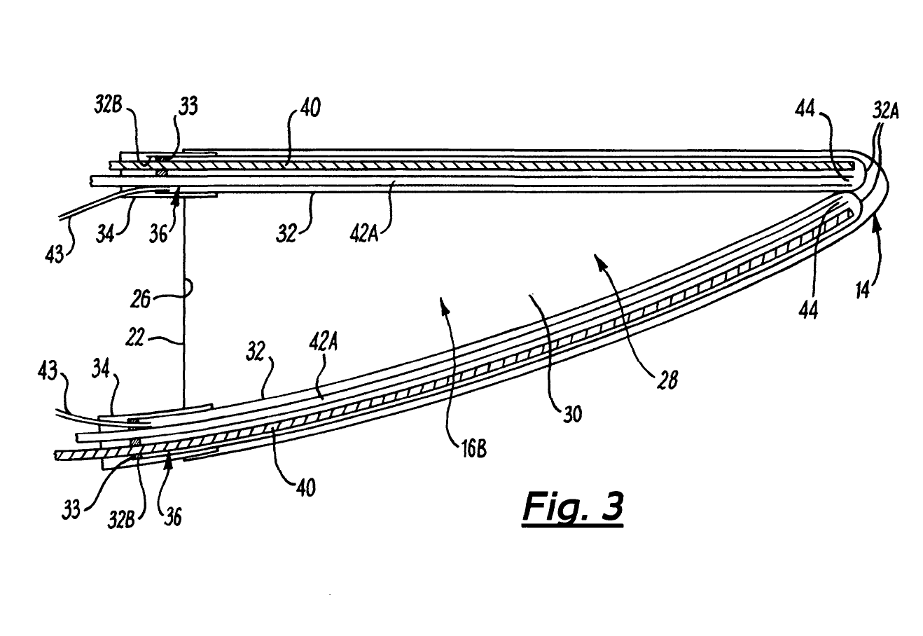

FIG. 2 is a top plan view of a plurality of segments provided to form the longitudinal wind turbine blade section shown in FIG. 1;

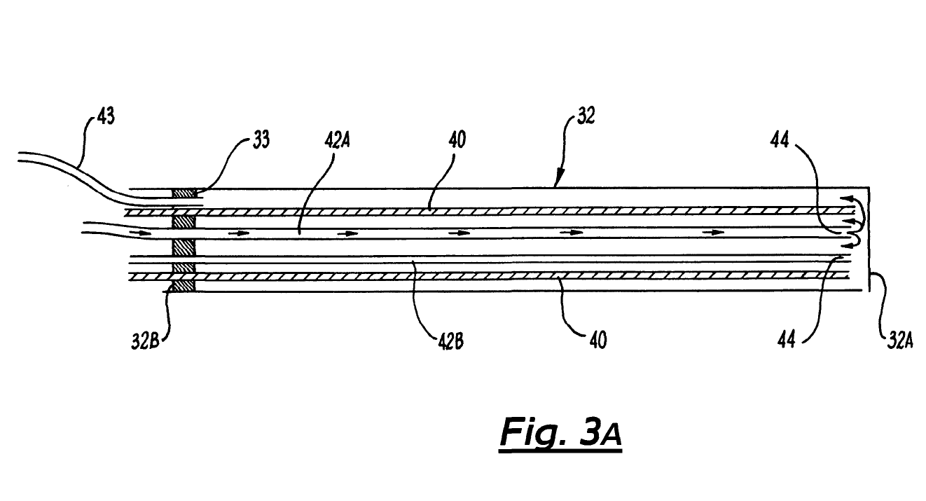

FIG. 3 is a top plan view of a tip segment;

FIG. 3A is a close up view of the holding member in the tip segment shown in FIG. 3;

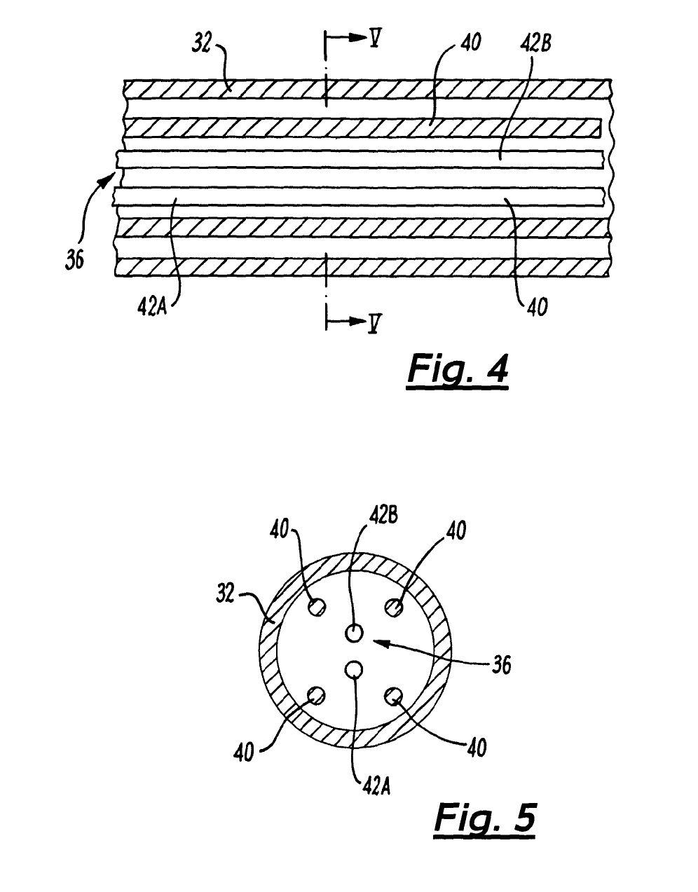

FIG. 4 is a sectional side view of a tendon used in securing the segment shown in FIG. 1 to each other;

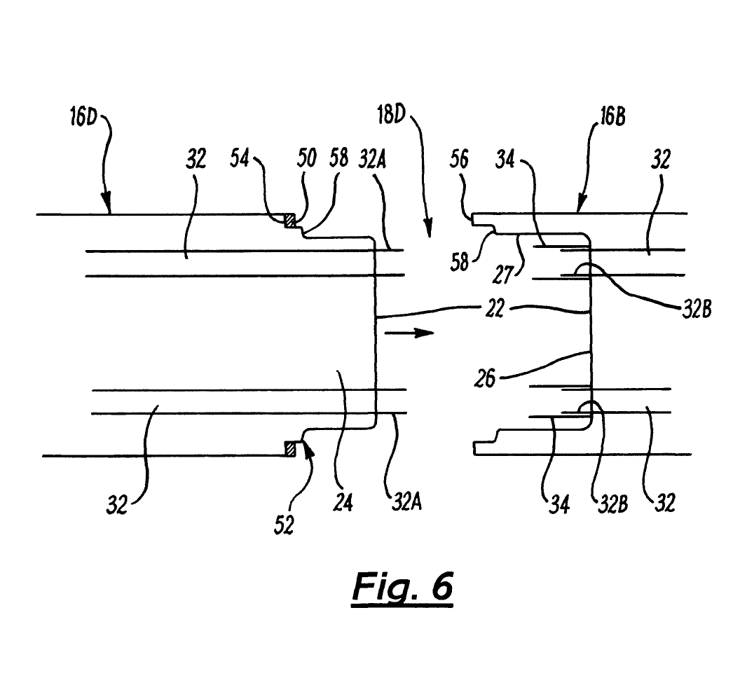

FIG. 5 is a view along the lines V-V in FIG. 4;

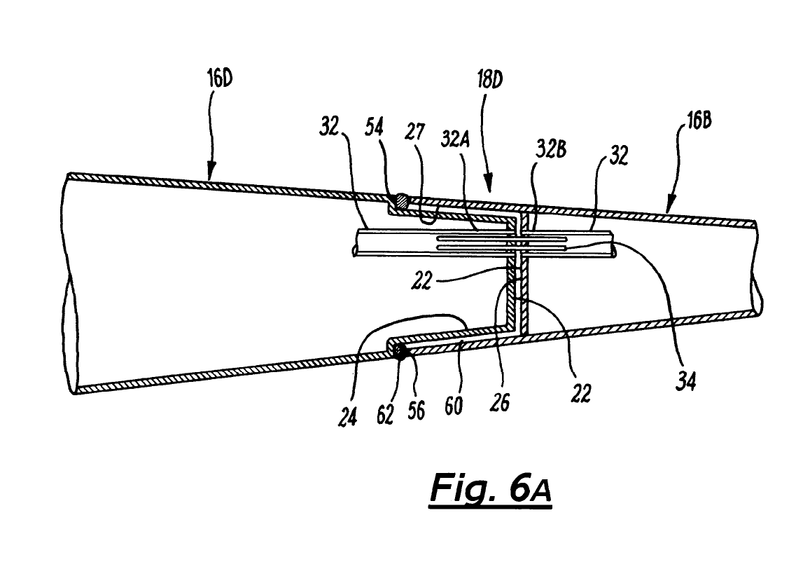

FIG. 6 is a diagrammatic view showing the connection to each other of two adjacent segments of the article shown in FIG. 1;

FIG. 6A is a diagrammatic view showing an alternative connection between adjacent segments of the article shown in FIG. 1;

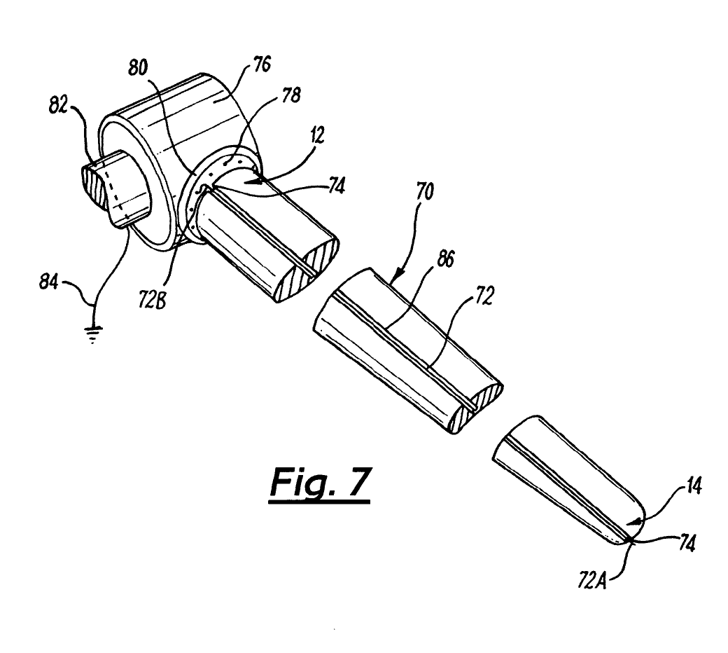

FIG. 7 shows an embodiment of a wind turbine blade having a lightning conductor;

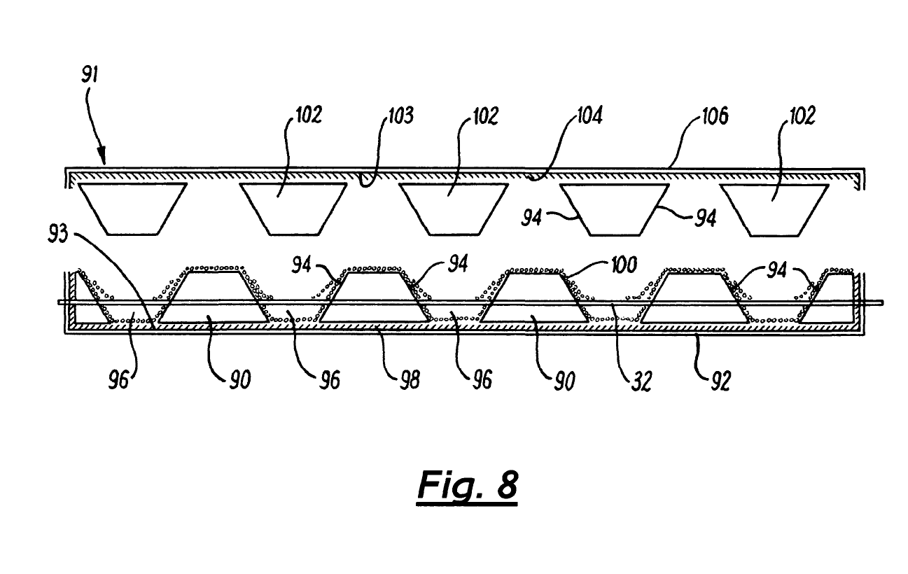

FIG. 8 shows a step in a further method of forming an article;

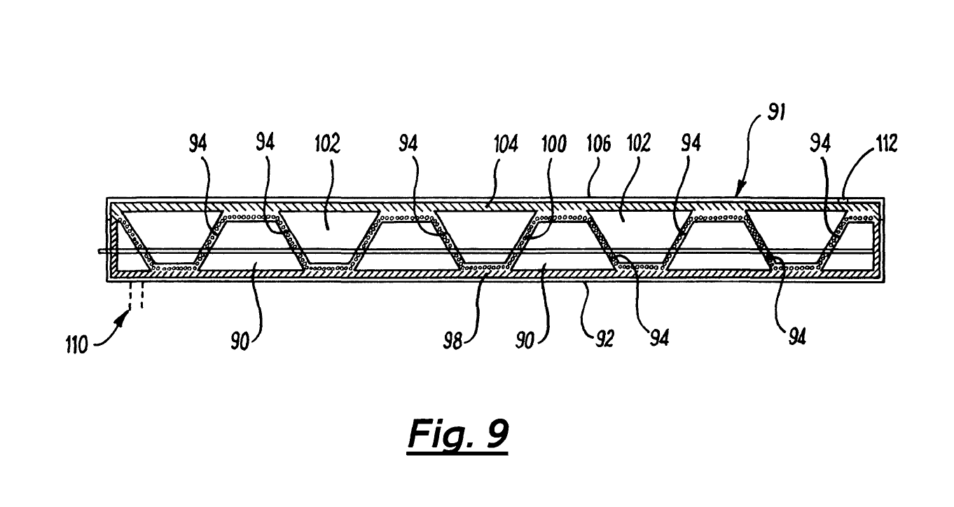

FIG. 9 shows a step in the method of forming an article subsequent to the step shown in FIG. 8;

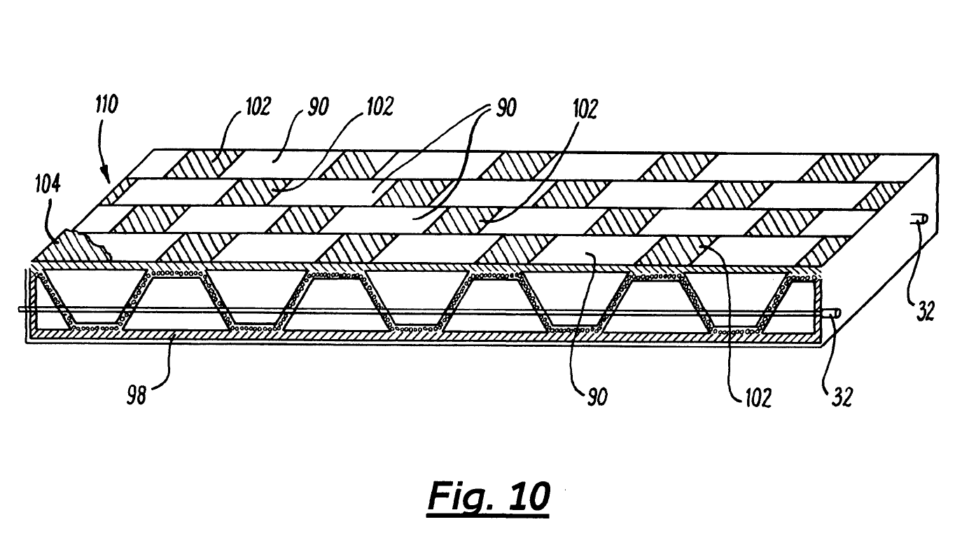

FIG. 10 shows an article formed by the method shown in FIGS. 8 and 9.

Referring to FIGS. 1 to 7 of the drawings, a longitudinal half section 10 of a wind turbine blade is shown, which has a root 12 and a tip 14. The shape of the wind turbine blade shown in FIG. 1 is representative of a wind turbine blade, and would be understood by those skilled in the art.

FIG. 2 shows a stage in a method forming the wind turbine blade shown in FIG. 1. FIG. 2 shows a plurality of segments 16, which comprise a root segment 16A, a tip segment 16B, and intermediate segments 16C and 16D.

The segments 16A to 16D are formed from a composite plastics material, such as glass reinforced epoxy resin, and would be formed in a manner known in the art. The tip segment 16B is shown in more detail in FIG. 3.

FIG. 1 shows a longitudinal half section 10 of the turbine blade, formed after the segments 16 are connected together. The half section 10 comprises a plurality of segments 16A, 16B, 16C and 16D which are connected together at junctions 18A, 18C and 18D, with the junction 18A being between the segments 16A and 16C, junction 18D being between junctions 16D and 16B, and the junction 18C being between the segments 16C and 16D.

The segments 16A, 16B, 16C and 16D are connected securely to one another by a pair of tendons 20, which extend from the root 12 to the tip 14. The construction of the tendons 20 and their method of manufacture are described below.

As can be seen from FIG. 1, the segments 16A, 16B, 16C and 16D have engaging ends 22 in the form of walls. The segments 16A, 16B, 16C and 16D include co-operating formations at the engaging ends 22. The co-operating formations comprise a spigot 24 which is received in a socket 26, the socket 26 being defined by the open end walls 27 of the respective segments 16B, 16C or 16D.

Referring to FIG. 3, the tip segment 16B comprises a main body 28, which defines a shallow recess 30, in which is provided a holding member in the form of a tubular sheath 32, having a distal end 32A and a proximal end 32B.

The tubular sheath 32 extends from the tip region 14 of the tip segment 16B to the engaging end 22, and just beyond. A sleeve 34, in the form of an external sleeve, is provided over the end of the tubular member 32 and extends beyond the engaging end 22. If desired, the sleeve 34 may be an internal sleeve, as shown in FIG. 6A. The purpose of the sleeve 34 is explained below.

An elongate connecting arrangement 36, which comprises a plurality of elongate filaments 40 and first and second elongate delivery tubes 42A, 42B are arranged within the tubular sheath 32. For reasons of clarity FIG. 3 shows only the first elongate delivery tube 42A. FIG. 3A shows the first and second elongate delivery tubes 42A, 42B. A region of the elongate connecting arrangement 36 is shown in more detail in FIGS. 4 and 5.

The elongate filaments can be formed by any suitable method that would be known to the skilled person, for example, pultrusion.

Each of the first and second elongate delivery tubes 42A, 42B has a distal end 44 (see FIG. 3) which, when installed, is at the tip of the longitudinal half segment 10 of the wind turbine blade. Each of the first and second delivery tubes 42A, 42B also has a proximal end at the root 12 of the longitudinal half segment 10 of the blade.

As can be seen from FIG. 2, each of the segments 16A, 16B, 16C, 16D also includes a tubular sheath 32 which are arranged in the respective segments 16A, 16B, 16C, 16D so that the ends of each tubular sheath 32 are aligned with the tubular sheaths 32 in the adjacent segment 16A, 16B, 16C or 16D.

In order to insert the plurality of elongate filaments 40 and the first and second elongate delivery tubes 42A, 42B into the tubular sheaths 32 of the tip segment 16B, the plurality of elongate filaments 40 and the first and second elongate delivery tubes 42A, 42B are first inserted into the tubular sheath 32 of the tip segment 16B, and then through the tubular sheaths 32 in each of the intermediate segments 16D and 16C and thereafter into the tubular sheath 32 of the root segment 16A.

Thus, when so inserted, the plurality of elongate filaments 40 and the first and second elongate delivery tubes 42A, 42B extend from the tip 14 of the tip segment 16B through the tubular sheaths 32 of the intermediate segments 16D, 16C and through the tubular sheaths 32 of the root segment 16A to extend outwardly therefrom at the root 12.

When the plurality of elongate filaments 40 and the first and second elongate delivery tubes 42A, 42B are arranged within the tip segment 16B, as shown in FIG. 3, an indicator tube 43 is inserted into the proximal end 32B of each tubular sheath 32. The proximal end 32B is then provided with a seal 33, for example of putty or a similar material. A close up of the tubular sheath 32 is shown in FIG. 3A.

A securing composition, for example in the form of a curable resin, such as a curable epoxy resin or polyester resin is then injected into the first elongate delivery tube 42A at the proximal end thereof at the root 12. It is desirable that the resin is not reinforced, in order to ensure a low viscosity, but it will be appreciated that a glass reinforced resin can be used.

The injected securing composition passes along the first elongate tube 42A and out of the distal end 44 thereof into the tubular sheath 32. The distal end 32A of the tubular sheath 32 has been sealed prior to the arrangement of the sheath 32 in the tip segment 16B, thereby preventing the securing composition from flowing out of the tubular sheath 32 at its distal end 32A.

Thus, the continued injection of the securing composition into the first elongate delivery tube 42A causes the securing composition to flow back down the tubular sheath 32 in the tip segment 16A to its proximal end 32B.

When the securing composition emerges from the proximal end 32B of the tubular sheath 32 in the tip segment 16B, the injection of the securing composition is halted. The securing composition is then allowed to cure, thereby securing the elongate filament 40 to the tubular sheath 32 in the tip segment 16B.

The remaining segments 16A, 16C and 16D are then pulled together so that their engaging ends 22 engage each other, and the spigots 24 are received in the sockets of the adjacent segments 16C, 16D and 16B.

Prior to this, the second elongate delivery tube 42B is cut so that a new distal end is provided in the intermediate segment 16D, adjacent the end 22 of the tip segment 16B. The purpose of this, as will be explained below, is to allow injected securing composition to pass out of the second elongate delivery tube 42B into the tubular sheath 32 in the intermediate segment 16D. Thus, each of the tubular sheaths 32 in the remaining segments 16A, 16C and 16D are filled with the securing composition.

Alternatively, the second elongate delivery tube 42B is formed to be of a length that the distal end thereof is at the distal end of the segment 16D when the segments are pulled together.

The segments 16 are pulled together, so that the spigots 24 of each segment 16 are received in the respective sockets 26. The filament 40 can be tensioned to the desired tension, and the securing composition can be injected into the second elongate delivery tube 42B at the region where it extends from the root 12.

The injection of the securing composition into the second elongate delivery tube 42B is continued until securing composition emerges from the further indicator tubes 43 in the tubular sheath 32 at the root 12. This is an indication that all of the tubular sheaths 32 are filled with the securing composition, which is then allowed to cure.

An alternative method of filling the sheath 32 in each segment 16A, 16B, 16C, and 16D with the securing composition is as follows. The tubular sheath 32 is arranged in the tip segment 16B so that it protrudes beyond the tip 14 thereof. The filaments 40 are then introduced into the sheath 32 at the distal end 32A and the filaments 40 are then fed into the tubular sheath 32 continued until they protrude from the end of the sheath 32 at root section 16A. An indicator tube (not shown) is then inserted into the end of the sheath 32 at its proximal end at the root section 16A. An injection tube (not shown) is inserted into the sheath 32 at its distal end 32 A. The injection tube is provided so that the resin can be injected into the sheath 32 at its distal end 32A, which protrudes from the tip 14.

The segments 16A, 16B, 16C and 16D are then joined together in the same manner as described above before the securing composition is injected.

The proximal end 32B of the sheath 32 in the root segment 16A is sealed with a seal 33 in the same way as described above.

The securing composition is then injected into the tubular sheath 32 via the distal end 32A thereof at the tip segment 16B. The securing composition flows along each of the sheaths 32 in the respective segments 16D, 16C and 16A in sequential order.

When the securing composition reaches the proximal end of the root segment 16A, the securing composition emerges therefrom via the indicator tube 43. This indicates to those working on the article that all of the sheaths 32 are filled with the securing composition, which is then allowed to cure.

After curing of the securing composition, the joined tubular sheaths 32, the filaments 40 and the cured securing composition together constitute a tendon 20. The segments 16A, 16B, 16C and 16D are, thus, securely connected together by the tendons 20.

The drawings show the provision of two tendons 20 in the half section 10, and it will be appreciated that the above described process applies for each of the tendons 20. Similarly, the other longitudinal half section of the wind turbine blade is formed in the same way as described above. The two half sections can then be attached to each other using techniques known in the art.

There is thus described a wind turbine blade, a longitudinal half section of a wind turbine blade, and a method of forming a wind turbine blade and a longitudinal half section of a wind turbine blade, which are suitable for use in the formation of large blades, for example, of a length greater than 15 metres, such as 40 or 60 metres. The formation of the blade can be carried out at the site of the wind turbine, thereby avoiding problems associated with transport of such long wind turbine blades.

FIG. 6 shows a junction 18 between two adjacent segments 16. For example, the adjacent segments could be the tip segment 16B and the segment 16D adjacent thereto, whereby the junction 18 is junction 18D.

As can be seen, the spigot 24 on the distal end of the segment 16D is received in the socket 26 at the proximal end of the tip segment 16B. The distal end 32A of the sheaths 32 in the segment 16D extend beyond the spigot 24.

Similarly, the distal ends 32B of the spigots 32 in the tip segment 16B extend into the socket 26. The sleeves 34 are provided on the proximal end regions 32B of the sheaths 32 in the tip segment 16B.

The distal ends 32A of the sheaths 32 in the segment 16D are aligned by the connecting arrangements 36 (not shown in FIG. 6) that extend through the sheaths 32. This alignment allows the distal end 32A to be received in the sleeves 34 when the spigot 24 is received in the socket 26.

In order to ensure a sealed joint between the two segments 16B, 16D, an endless seal 50 is provided around the outer region 52 of the spigot 24. The seal 50 is provided on a shoulder 54 that extends inwardly from the outer surface of the segment 16D.

The shoulder 54 is aligned with a projecting portion 56 on the proximal end of the tip segment 16B. If desired, further formations, such as strengthening formations 58 can be provided on the spigot 24 and at the socket 26.

Alternatively, the strengthening formations 58 can be omitted from each of the segments 16B, 16D. In a further alternative, the endless seal 50 could be provided within the socket 26 on the engaging end 22 of the segment 16B, in engagement with the projecting portion 56.

In the embodiment shown in FIG. 6, the seal 50 can be a rubber seal, similar to an o ring seal, but shaped to conform to the configuration of the segments 16. Alternatively, the segments 16B, 16D could be joined together without a seal and thereafter, a sealing material, for example a putty, can be injected into a gap between the respective proximal and distal end regions of the segment 16B, 16D.

Although the above description has been made with a reference to the tip segment 16B and the adjacent segment 16D, it will be appreciated that it also applies, with any relevant changes, to all of the adjacent segments 16.

Various modifications can be made without departing from the scope of the invention. For example, injection ports may be provided at each of the junctions 18A, 18C as well as at the root 12 to inject fluid into each respective tubular sheath 32.

FIG. 6A shows an alternative junction 18 between two adjacent segments 16, such as the junction 18D between the tip segment 16B and the segment 16D adjacent thereto. The tubular sheaths 32 are connected to each other by a sleeve 34 in the form of an internal sleeve. The sleeve 34 is received in the adjacent ends 32A and 32B of the respective sheaths 32. The filaments 40 and the first and second delivery tubes 42A, 42B are not shown in FIG. 6A for clarity.

The embodiment shown in FIG. 6A has many of the features of the embodiments described above, and these have been designated with the same reference numerals as above.

An frustoconical space 60 is defined between the spigot 24 of the segment 16D, and the end wall 27 defining the socket 26. A resin can be injected into the annular space 60 to provide a seal between the spigot 24 and the wall 27 defining the socket 26.

An epoxy putty 62 is provided as an annular seal between the shoulder 54 and the projecting portion 56.

In yet another embodiment, a lightning conductor may be provided in the blade to extend from the tip to the root.

In FIG. 7, a wind turbine blade 70 is shown. The wind turbine blade 70 can be manufactured by the method described above, and incorporates a lightning conductor 72 which extends from the root 12 to the tip 14. The wind turbine blade 70 is shown in separate broken parts, in order that the tip 14 and the root 12 can be shown in the drawing, otherwise the length of the wind turbine blade 70 will prevent it from being shown in detail in the drawing.

The lightning conductor 72 has a distal end region 72A which extends out of the tip 14 of the wind turbine blade 70. The region around the distal end region 72A of the lightning conductor 72 at the tip 14 may be sealed by a seal 74. Similarly, the lightning conductor 72 has a proximal end region 72B which extends from the root 12 of the wind turbine blade 70. The region around the distal end region 72B is also sealed by a seal 74 where it exits from the wind turbine blade 70.

The wind turbine blade 70 is mounted to a blade connection box 76 by suitable means known in the art, for example a plurality of bolts 78 which extend through a flange 80 into suitable apertures in the blade connection boss 76. The proximal end 72B of the lightning conductor 72 is secured to one of the bolts 78, by means that allows electrical connection therewith. The blade connection boss 76 is mounted on a shaft 82 which drives the electrical power generating apparatus (not shown) in a manner as would be understood by those skilled in the art. A suitable lightning collector 84 is mounted in electrical association with the shaft 82 so that, in the event that the lightning conductor 72 is struck by lightning, the electricity is transmitted along the lightning conductor 72 from the shaft 82 to the lightning connector 84 and thereafter to earth.

The lightning conductor 72 is mounted in the wind turbine blade 70 in a containment tube 86, having a similar form to the sheaths 32 described above. If desired, the containment tube 86 can be in the form of a plurality of individual containment tube portions which are connected together in a similar manner to that described above in relation to the sheaths 32.

Reference is now made to FIGS. 8, 9 and 10, which show an alternative method of forming an article, for example a wind turbine blade. The method shown in FIGS. 8, 9 and 10 and described below allows both half sections 10 of a wind turbine blade segment to be made as a unitary moulding.

Referring to FIG. 8, a first moulding member in the form of, for example a lower mould part 92 having a lower face 93, is provided. A skin reinforcing material 98 is disposed on the lower face 93. The reinforcing material 98 may comprise glass fibre or carbon fibre strips, or other suitable reinforcing matter.

A plurality of first forming elements 90 are arranged in a mould 91 on the reinforcing material 98. The first forming elements 90 are formed of a closed cell polystyrene material, and have a profile in the shape of an isosceles trapezium having tapering front and rear sides 94.

The first forming elements 90 are spaced from each other so that recesses 96 are defined between adjacent first forming elements 90.

If desired, a tubular sheath 32 for receiving a connecting arrangement 36 (not shown in FIG. 8) may be arranged within the lower mould part 92. The first forming elements 90 can be suitably shaped to accommodate the tubular sheath.

When the first forming elements 90 and, if desired, the tubular sheath 32, are arranged in the lower mould part 92, further reinforcing material 100 is arranged over the first forming elements 90. It is desirable that the further reinforcing material 100 is arranged to cover the first forming elements 90, and to enclose the tubular sheath 32, if present. It is also desirable that the further reinforcing material 100 contacts the first mentioned reinforcing material 98 provided in the lower mould part 92.

The next stage is for a plurality of second forming elements 102 to be arranged in the lower mould part 92. As can be seen from FIG. 8, the second forming elements 102 are generally the same as the first forming elements 90, being formed of the same material and having a profile in the shape of an isosceles trapezium, having tapering sides 94. The second forming elements 102 are arranged upside down relative to the first forming elements 90. The second forming elements 102 are arranged in the recesses 96 between the adjacent first forming elements 90.

When the second forming elements 102 have been arranged in the lower mould part 92, the second forming elements 102 stand proud of the first forming elements 90. Additional reinforcing material (not shown) is arranged thereon to cover the second forming elements 102. A moulding material, for example a resin can then be disposed in the lower mould part 92.

The mould 91 further includes a second moulding member in the form of an upper mould part 106, having an upper surface 103. A further reinforcing material 104 is arranged on the upper surface 103. The further reinforcing material is the same as the reinforcing material 98 and 100.

The next stage is for the upper mould part 106 to be disposed on the first mould part 92 to provide the mould 91, as shown in FIG. 9, in a closed condition

When the upper mould part 106 has been disposed on the lower mould part 92, the two mould parts 92, 106 are clamped together to apply pressure to the upper and lower mould parts 92, 106. Since the second forming elements 102 stand proud of the first forming elements 90, they are pushed into the recesses 96 when the upper and lower mould parts 92, 106 are pressed together. In this condition, the reinforcing material 98, 100 and 104 is pressed onto the first and second forming elements 90, 102 to provide reinforcement throughout the article. When the mould 91 is closed, the reinforcing material 98, 104 contacts the first and second forming elements 90, 102 in a staggered pattern across the mould as shown in FIG. 10.

If desired, instead of adding the resin before closing the mould 91, the resin can be injected into the mould 91 after the mould is closed by the upper mould part 106 having been clamped onto the lower mould part 92. In such a case, the resin is injected into an injection port 110 (shown in broken lines in FIG. 9) in the lower mould part 92, and a breather aperture 112 is defined in the upper mould part 106 to allow air and any excess resin to escape.

The compression of the first and second forming elements 90, 102 onto each other forces the resin to fully impregnate the fibres of the reinforcement material. 98, 100, 104.

Thus, the material in the mould 91 is compressed together, and the pressure is applied until the resin has cured.

FIG. 10 shows a completed article 110 after the moulding process has taken place. The article comprises a lower film of reinforcing material 98, an upper film of reinforcing material 104 (most of which is not shown in order that the reinforcing elements can be seen) and a plurality of first and second forming elements 90, 102 which, in effect, provide a plurality of cross bracing members across and through the article, thereby imparting enhanced strength and stability to the embodiment of the article described herein.

FIG. 10 also shows two tubular sheaths 32 extending through the first and second forming elements 90, 102.

The above method has been described using drawings which show a generally rectangular article 110 being formed. It will be appreciated that the articles 110 so formed can be of any desired shape, and it is desirable that the article 110 is in the form of a segment 16 of a wind turbine blade which can be connected to further segments to provide a whole wind turbine blade. The cross bracing has the advantage in the embodiment described and shown herein that the skins of the article 110 can be made lighter and stronger than prior art similar articles.

There is thus described a method of forming an article, for example a segment of a wind turbine blade which is light and yet provides strength and rigidity to the blade. A wind turbine blade could be formed by joining the segment to further segments in a manner similar to that described above with reference to FIGS. 1 to 7.

It will be appreciated that the method described with reference to FIGS. 8, 9 and 10 could be used to manufacture a wind turbine in two longitudinal skin halves, rather than in segments as described above. In such a method, the forming elements 90, 102 would provide suitable strengthening for the blade, thereby improving strength and stiffness and allowing thinner skin halves to be used. Such a blade could be manufactured without the use of the tendons 20.

1.-72. (canceled)

73. A method of forming an aerodynamic arrangement comprising providing a plurality of segments, providing elongate connecting means, and connecting the segments to one another with the elongate connecting means, and the method further includes introducing a curable securing composition into the connecting means, and allowing the securing composition to cure.

74. A method according to claim 73, wherein the plurality of segments comprise a tip segment providing a tip of the aerodynamic arrangement, and a root segment providing a root of the aerodynamic arrangement, and the method comprises introducing the securing composition into the connecting means such that the securing composition extends along substantially the length of the connecting means from the tip to the root.

75. A method according to claim 73, wherein the elongate connecting means comprises a connecting tube extending through the segments, and the method comprises introducing the securing composition into the connecting tube such that the securing composition extends along substantially the length of the connecting tube.

76. A method according to claim 75, including arranging a respective holding member in each segment, and connecting the holding members of adjacent segments to each other to form the connecting tube, and further including arranging an elongate connecting arrangement to extend through the holding members in each segment, wherein the connecting arrangement comprises at least one elongate connecting element.

77. A method according to claim 76, wherein the method comprises arranging the elongate connecting means to extend from the tip segment to the root segment, and wherein the, or at least one, elongate connecting element comprises an elongate introducing means for introducing the curable material, the elongate introducing means having distal and proximal ends, the distal end being arranged adjacent the tip of the aerodynamic arrangement, and the proximal end being arranged adjacent the root of the aerodynamic arrangement.

78. A method according to claim 77, wherein the method comprises arranging the elongate connecting elements in the holding member at the tip segment, and the step of arranging the elongate elements in the tip segment includes arranging the introducing means in the holding member of the tip segment prior to connecting the segments to one another

79. A method according to claim 78, including a first securing stage comprising introducing the securing composition through the introducing means into the holding member in the tip segment, wherein the first stage includes introducing the securing composition into the introducing means so that the securing composition passes through the introducing means, and passes out of the distal end of the introducing means into the holding member in the tip segment and thereafter flows through the holding member.

80. A method according to claim 78, wherein each segment has at least one co-operating formation at a junction with an adjacent segment, the co-operating formations on adjacent segments co-operating with each other to align the segments with each other, and the segments being connected to one another at junctions between adjacent segments.

81. A method according to claim 80, wherein each segment has at least one connecting edge to engage the connecting edge of the, or each, adjacent segment when the segments are connected to one another, wherein the method includes arranging the segments in alignment with each other, such that the connecting edge of each segment engages the connecting edge of the adjacent segment, and wherein the step of arranging the connecting edges of adjacent segments in engagement with each other comprises joining the holding members of adjacent segments to one another, each joining member comprising a sleeve extending around, or inside, the end regions of adjacent holding members.

82. A method according to claim 81 wherein the method includes arranging the elongate connecting arrangement to extend through the holding members of each segment, and introducing a securing composition into the segments, and wherein the step of engaging the segments with one another comprises pulling the segments together with the connecting arrangement extending through the holding members in each segment, so that the joining members on each holding member are arranged on the end region of adjacent holding members across the junction between said adjacent holding members.

83. A method according to claim 82, wherein the introducing means comprises first and second introducing members, the securing composition being introduced via the first introducing member into the tip segment, and the securing composition being introduced into the, or each, remaining segment via the second introducing member, and the method further includes introducing the securing composition into the second introducing member so that the securing composition passes through the second introducing member, and passes out of the distal end of the second introducing member into the holding member in the segment adjacent the tip segment and thereafter flows through the holding members of each remaining segment.

84. An aerodynamic arrangement comprising a plurality of segments, and elongate connecting means extending through the segments to connect the segments to one another, wherein the elongate connecting means comprises a holding member in at least one of the segments, and a cured securing composition in the holding member.

85. An aerodynamic arrangement according to claim 84, wherein the plurality of segments comprise a tip segment providing a tip of the aerodynamic arrangement and a root segment providing a root of the aerodynamic arrangement, the securing composition extending along substantially the length of the connecting means from the tip to the root.

86. An aerodynamic arrangement according to claim 84, wherein the elongate connecting means comprises a respective holding member in each segment, the holding members being connected to one another to provide the connecting tube, and wherein each holding member comprises an elongate tubular member and the elongate connecting arrangement extends axially through the connecting tube along substantially the length of the connecting tube.

87. An aerodynamic arrangement according to claim 86, wherein the connecting arrangement is secured to the holding members in each segment by the securing composition.

88. An aerodynamic arrangement according to claim 86, wherein the elongate connecting arrangement extends through the holding members, and the elongate connecting arrangement comprises at least one elongate connecting element.

89. An aerodynamic arrangement according to claim 88, wherein the elongate connecting arrangement comprises a plurality of the elongate connecting elements, the elongate connecting elements extending side by side through the holding members, and wherein at least one of the elongate connecting elements comprises introducing means through which the securing composition can be introduced into at least one of the holding members.

90. An aerodynamic arrangement according to claim 86, wherein the elongate connecting means includes joining members to join to each other the end regions of the holding members of adjacent segments, and wherein each joining member comprise a sleeve, the sleeve being selected from: an external sleeve extending around the end regions of the holding members of adjacent segments to join the holding members to each other; an internal sleeve, the end regions of the holding members extending around the internal sleeve.

91. An aerodynamic arrangement according to claim 84, wherein each segment has at least one co-operating formation so that the, or each, co-operating formation on adjacent segments can co-operate with each other to align the segments with each other.

92. A moulding method comprising arranging a plurality of first forming elements in a first moulding member, such that the first forming elements define a plurality of recesses between each other in the first moulding member, arranging a plurality of second forming elements in the first moulding member in the recesses, such that each recess receives at least one of the second forming elements, presenting the first and second moulding members to each other, arranging a moulding material in the mould, and pressing the first and second moulding members onto each other to compress the forming elements and form an article.
